(19) United States
(12) Patent Application Publication
(10) Pub. No.: US 2016/0275522 A1
(43) Pub. Date: Sep. 22, 2016

(54) PROVIDING A CUSTOMER INTERACTION STYLE TO A SUPPORT TECHNICIAN

(71) Applicant: CA, INC., New York, NY (US)

(72) Inventors: LIXIN ZHANG, Thornhill (CA); GAIL VALLANCE, Thornhill (CA); RICHARD ROZENTALS, Thornhill (CA); EFRAIM MOSCOVICH, New York, NY (US); JUDITH KRUNTORAD, Framingham, MA (US); HIREN MANDALIA, Lisle, IL (US)

(73) Assignee: CA, INC., New York, NY (US)

(21) Appl. No.: 14/661,806

(22) Filed: Mar. 18, 2015

(51) Int. Cl. G06Q 30/00; G06F 17/30

(52) U.S. Cl. CPC G06Q 30/016; G06F 17/30528; G06F 17/30867

(57) ABSTRACT

A computer implemented method and system for providing customer information to a support technician that includes, with a computer, analyzing electronic records related to a particular customer to determine a customer interaction style, and, with a computer, displaying a set of guidelines based on the particular customer's interaction style to a technician in a support interaction with the particular customer. The customer interaction style includes a customer focus dimension, the customer focus dimension indicating a degree to which the particular customer seeks an explanation with a provided solution; a customer work style dimension, the customer work style dimension indicating a rating of the particular customer along a range from self-sufficient to support reliant, and, a customer expression dimension, the customer expression dimension indicating an amount in which the particular customer engages in discussion unrelated to the provided solution.

### BACKGROUND

Many manufacturers provide product support to their customers. Typically, the customer contacts the manufacturer's support service by phone or online. The customer can then ask questions to better understand the product. In some cases, the customer may simply need more information about how to use the product. In other cases, the product may need to be reconfigured or may be defective, and the customer needs help to proceed.

### BRIEF SUMMARY

According to one aspect of the present specification, a method is implemented by a computer for providing customer information to a support technician. In one example, the method includes, with a computer, analyzing electronic records related to a particular customer to determine a customer interaction style, the customer interaction style including: a customer focus dimension, the customer focus dimension indicating a degree to which the particular customer seeks an explanation with a provided solution; a customer work style dimension, the customer work style dimension indicating a rating of the particular customer along a range from self-sufficient to support reliant; and a customer expression dimension, the customer expression dimension indicating an amount in which the particular customer engages in discussion unrelated to the provided solution. The method further includes, with a computer, generating and displaying a set of guidelines based on the particular customer's interaction style to a technician in a support interaction with the particular customer.

According to another aspect of the present specification, a system for presenting a customer interaction style to a technician. In one example, this system includes a processor; memory to communicate with the processor; a computer monitor to communicate with the processor; and a support style system. The support style system includes an analyzing module to analyze electronic records related to a particular customer to determine a customer interaction style and generate a set of guidelines based on the customer interaction style. The customer interaction style includes a customer focus dimension, the customer focus dimension indicating a degree to which the particular customer seeks an explanation with a provided solution; a customer work style dimension, the customer work style dimension a rating of the particular customer along a range from self-sufficient to support reliant; and a customer expression dimension, the customer expression dimension quantifying an amount in which the particular customer engages in discussion unrelated to the provided solution. The system further includes a displaying module to display, on the computer monitor, the set of guidelines during an interaction between a support technician and the particular customer.

According to yet another aspect of the present specification, a computer program product for providing customer information to a technician is described. In one example, the computer program product includes a non-transitory computer readable storage medium, said computer readable storage medium having computer readable program code embodied therewith, this computer readable program code including program instructions that, when executed, cause a processor to: analyze electronic records related to a particular customer to determine a customer interaction style and generate a set of guidelines based on the customer interaction style. The customer interaction style includes: a customer focus dimension, the customer focus dimension indicating a degree to which the particular customer seeks an explanation with a provided solution; a customer work style dimension, the customer work style dimension indicating a rating of the particular customer along a range from self-sufficient to support reliant; and a customer expression dimension, the customer expression dimension indicating an amount in which the particular customer engages in discussion unrelated to the provided solution. The instructions further cause display of the set of guidelines to a technician in a support interaction with the particular customer.

### BRIEF DESCRIPTION OF THE DRAWINGS

Aspects of the present specification are illustrated by way of example and are not limited by the accompanying figures, with like references indicating like elements.

FIG. 1A illustrates a system for providing customer information to a support technician, according to one example of the principles described herein.

FIG. 1B illustrates a display of a customer interaction style to a support technician, according to one example of the principles described herein.

FIG. 2A illustrates a system for presenting a customer interaction style, according to one example of the principles described herein.

FIG. 2B illustrates a display of a customer interaction style to a support technician, according to one example of the principles described herein.

FIG. 3 illustrates a system for presenting a customer interaction style, according to one example of the principles described herein.

FIG. 4 illustrates a diagram of a system for presenting a customer interaction style, according to one example of the principles described herein.

FIG. 5 illustrates a flowchart of a method implemented by a customer information presenting system, according to one example of the principles described herein.

FIG. 6 illustrates a diagram of a computer program product for presenting customer information, according to one example of the principles described herein.

Throughout the drawings, identical reference numbers designate similar, but not necessarily identical, elements.

### DETAILED DESCRIPTION

When seeking assistance from a customer support facility, each customer will have a different interaction or communication style based on a number of factors including, for example, customer personality, sophistication and experience with the type of product for which help is sought, time available, desire to understand the nature of the issue occurring and others. The satisfaction of the customer increases when a support technician provides a solution in an interaction style that matches that customer's preferences. However, unless the support technician has had recurring experiences with the customer so as to know that particular customer's interaction style, the support technician may be unable to communicate in the most effective interaction style with that particular customer.

The present specification describes a method and system for providing customer information to a support technician. The customer information includes an indication of a preferred customer interaction style. To convey the preferred customer interaction style to the support technician, the preferred customer expressly style may be explain in terms of a number of different dimensions or aspects of the customer's preferred interaction with the support service. For example, the customer interaction style may include a customer work style dimension that rates the particular customer along a range from self-sufficient to support reliant. This may help the support technician understand whether to explain the solution in simple or detailed terms. The customer interaction style may also include a customer focus dimension that indicates a degree to which the particular customer seeks an explanation behind the solution offered. Some customers may simply want a solution to the problem without an explanation of the problem or how the solution solves the problem. Other customers may want to understand the problem and/or the solution, perhaps so that they can address the problem themselves should it recur. The customer interaction style may also include a customer expression dimension that rates of the extent to which that particular customer typically engages in discussions unrelated to the product for which the customer is seeking support. Different customers may prefer differing amounts of discussion unrelated to the support being sought. Other dimensions may be defined for expressing a customer's expression style to the support technician. The customer interaction style provides a technician with information to build a positive customer relationship and improve productivity.

The subject matter described herein may be a system, a method, and/or a computer program product. The computer program product may include a computer readable storage medium (or media), having computer readable program instructions thereon for causing a processor to carry out aspects of the subject matter described herein.

As will be appreciated by one skilled in the art, aspects of the present specification may be illustrated and described herein in any of a number of patentable classes or context including any new and useful process, machine, manufacture, or composition of matter, or any new and useful improvement thereof. Accordingly, aspects of the present specification may be implemented as entirely hardware, entirely software (including firmware, resident software, micro-code, etc.) or combining software and hardware implementation that may all generally be referred to herein as a “circuit,” “module,” “component,” or “system.” Furthermore, aspects of the present specification may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but is not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present specification may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment, or offered as a service such as a Software as a Service (SaaS).

Aspects of the present specification are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions, when stored in the computer readable medium, produce an article of manufacture including instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various aspects of the present specification. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function, in combination with other claimed elements as specifically claimed. The description of the present specification has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

As will be appreciated from the discussion above, a technician that is inefficient in determining a customer interaction style may communicate with a customer in a manner that is ineffective. The decreased effectiveness of the communication decreases a customer's satisfaction with the support call. The technician may lack experience or time with the customer to determine an effective interaction style for that customer in a current support call.

According to the principles described herein, a system and method are described for displaying a guide to a customer's interaction style for use by a support technician who may have little or no experience with that customer. As described above, the customer interaction style may include a number of different dimensions that characterize the customer's mode of interacting with a support service. As described above, these may include a customer focus dimension indicating a degree to which the particular customer seeks an explanation to a solution, a customer work style dimension indicating a rating of the particular customer along a range from self-sufficient to support reliant, and a customer expression dimension rating the extent to which that particular customer likes to engage in discussions unrelated to the product support being requested.

A number of records related to a particular customer are analyzed to determine a customer interaction style characterizing that particular customer's behavior. A set of guidelines are displayed, based on the particular customer's interaction style, to a technician in a support interaction with the particular customer. The technician receives a set of guidelines for interacting with the customer, improving the effectiveness of the technician and enhancing the customer's experience with the support call. The technician uses the information to interact with the customer and to make the interaction more effective. The improved interaction increases the customer satisfaction with the support experience, increasing the likelihood that the customer will engage in repeat business.

As used in the present specification and in the appended claims, the term “support” means a service provided by a company to provide users with help or advice about a product the company sells.

As used in the present specification and in the appended claims, the term “focus” refers to the degree to which a customer acts toward the center of interest. A customer with a high level of focus on an issue desires the issue to be resolved at the exclusion of other information.

As used in the present specification and in the appended claims, the term “work style” means the method by which a person works and obtains information. A customer with an independent work style seeks to obtain information in a way that is independent of other people.

As used in the present specification and in the appended claims, the term “interaction style” means the method a customer uses to interact with a support technician. An interaction style provides information about the social habits of a customer during a support interaction.

As used in the present specification and in the appended claims, the term “dimension” means a particular aspect of a customer's communication or interaction style that can be characterized to aid future interaction with that customer. A dimension typically includes a range or metric used to define a corresponding aspect of the customer's interaction style that is being characterized.

As used in the present specification and in the appended claims, the term “guidelines” means a set of general rules, principles, or advice. Guidelines provide information as to a recommended course of action and behavior.

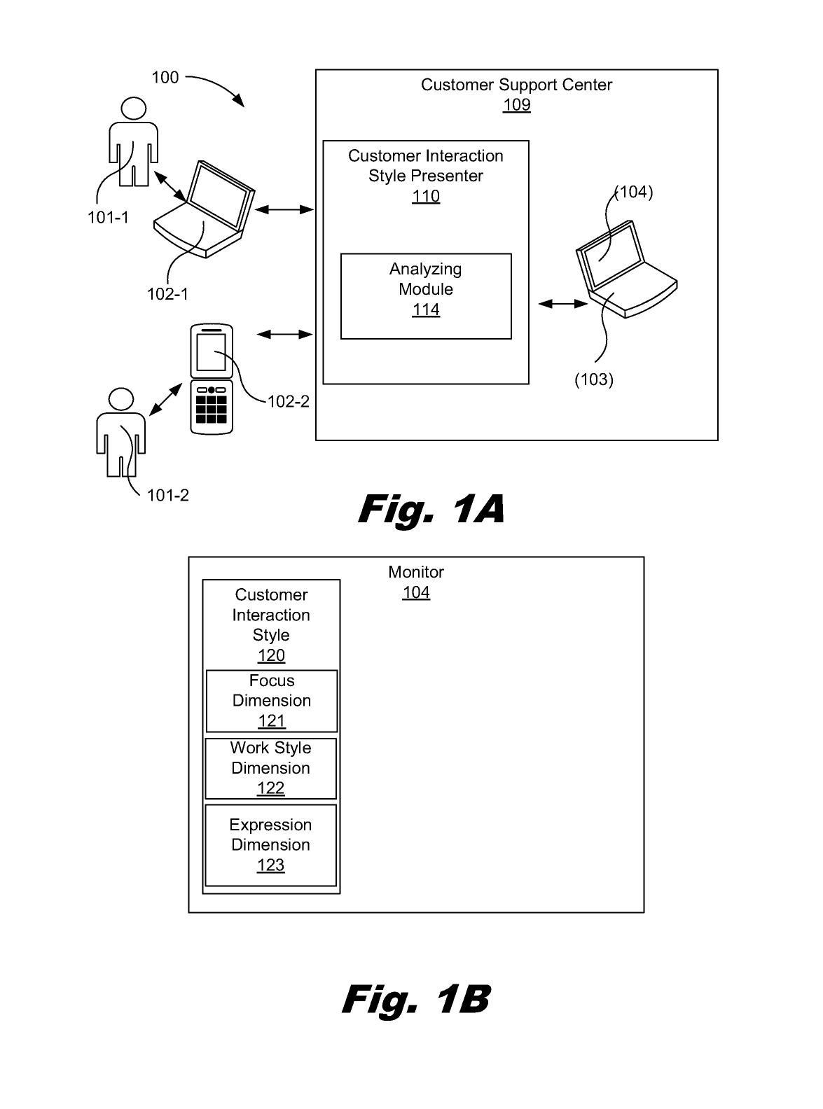

Referring now to the figures, FIG. 1A illustrates a system for presenting a customer interaction style, according to one example of the principles described herein. A number of customers contact a support center to interact with a technician. The customers use devices to contact the support center. The customers interact with the support center. The support center includes a customer interaction style presenter. The customer interaction style presenter includes an analyzing module. The analyzing module analyzes data associated with the customers to determine a customer interaction style for each customer. The customer interaction style is presented to a technician. The technician uses the customer interaction style to influence the interaction with the customer.

As illustrated in FIG. 1A, the presenting system (100) includes a customer support center (109). The customer support center (109) includes a customer interaction style presenter (110). The customer interaction style presenter (110) includes an analyzing module (114). The customer interaction style presenter is communicatively connected to a computer (103) used by a technician. The customer interaction style presenter (110) interacts with the computer (103) to display, on a monitor (104), a customer interaction style.

A number of different customers (101) use a number of different devices (102) to interact with the customer support center (109). A customer (101-1) uses a computer (102-1) to interact with the customer support center (109). Another customer (101-2) uses a telephone (102-2) to interact with the customer support center (109). The customers (101) each have a different interaction style. The interaction style of customer 101-1 is not the same as the interaction style of customer 101-2. The customer support center (109) receives information identifying a particular customer (101). The customer support center (109) provides the information to the customer interaction style presenter (110). The customer interaction style presenter (110) analyzes, using an analyzing module (114), the data associated with the customer (101). The analyzing module (114) analyzes the data associated with the customer (101) and determines the customer interaction style. The customer interaction style includes a customer focus dimension, the customer focus dimension indicating a degree to which the particular customer seeks an explanation to a solution, a customer work style dimension, the customer work style dimension indicating a rating of the particular customer along a range from self-sufficient to support reliant, and, a customer expression dimension, the customer expression dimension indicating a rating of an extent that the particular customer engages in discussions unrelated to supporting the particular customer's needs.

The customer interaction style presenter (110) displays the customer interaction style on a monitor (104), such that the customer interaction style is observed by a support technician. The technician uses the information to interact with the customer and to make the interaction more effective. The improved interaction increases the customer satisfaction with the support experience, increasing the likelihood that the customer will engage in repeat business.

FIG. 1B illustrates a display of a customer interaction style to a support technician, according to one example of the principles described herein. The customer interaction style is shown as it is displayed on a monitor of a device associated with a customer support technician.

As illustrated in FIG. 1B, a computer monitor (104) shows an example of a displaying a customer interaction style. The customer interaction style (120) includes a focus dimension (121), a work style dimension (122), and an expression dimension (123).

The focus dimension (121) represents a degree to which the particular customer seeks an explanation to a solution. A customer that shows a high degree of focus demonstrates a desire to receive an answer to a question as rapidly as possible.

The work style dimension (122) represents a rating of the particular customer along a range from self-sufficient to support reliant. A customer that is self-sufficient attempts to solve a problem without contacting support, or by using material published by the customer support center.

The expression dimension (123) represents a rating of an extent that the particular customer engages in discussions unrelated to supporting the particular customer's needs. A customer that engages in discussion unrelated to the support the customer needs may be dissatisfied when a technician does not engage in the conversation. A customer that does not engage in discussion unrelated to the support the customer needs will be dissatisfied with conversation unrelated to the support needs.

The presentation of the customer interaction style (120) provides information to the technician about the particular customer. Additional space is available on the monitor (104) to allow the technician access to other information. The customer interaction style (120) may be available for the duration of the customer support interaction. The customer interaction style (120) may be available for a portion of the customer support interaction.

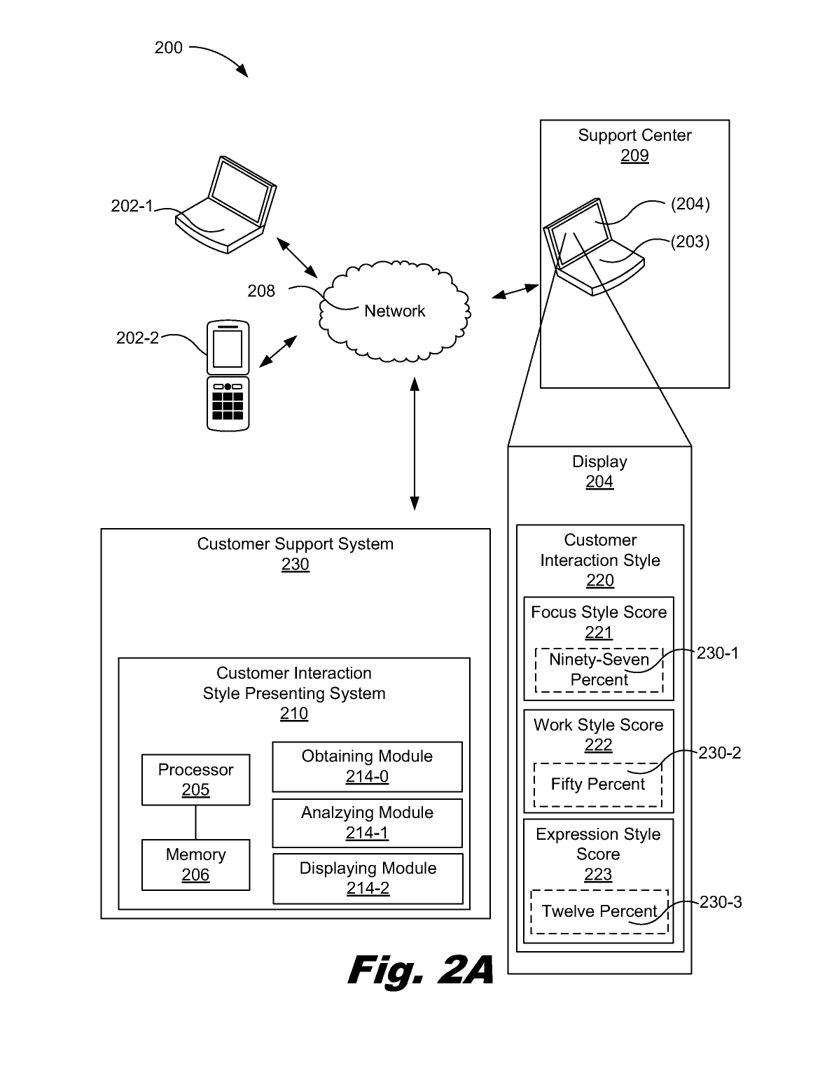

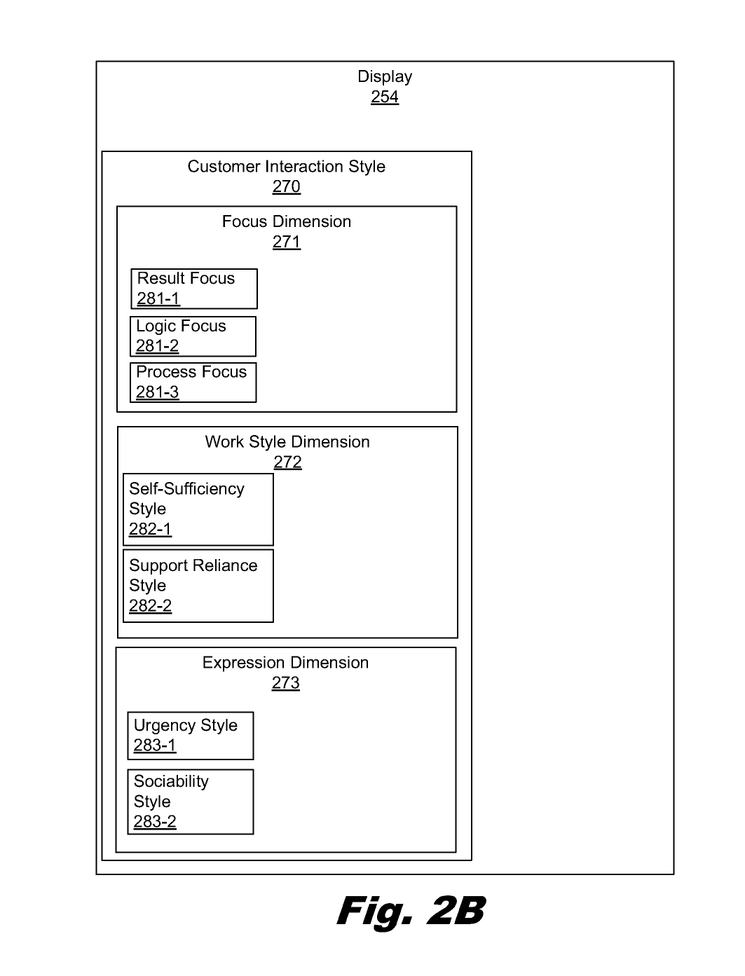

FIG. 2A illustrates a system for presenting a customer interaction style, according to one example of the principles described herein. As will be described blow, a number of customers initiate support interactions with a technician in a customer support center.

A number of customers contact a support center to interact with a technician. The customers use devices to contact the support center. The customers interact with the support center. The support center interacts with a customer interaction style presenter. The customer interaction style presenter includes an analyzing module. The analyzing module analyzes data associated to with the customers to determine a customer interaction style for each customer. The customer interaction style is presented to a technician. The technician uses the customer interaction style to influence the interaction with the customer. The support center may include the customer interaction style presenter, or may communicate with the customer interaction style presenter over a network.

As illustrated in FIG. 2A, the system (200) includes a number of customers that communicate with a support center (209) over a network (208). The customers use a number of devices (202) to communicate with the support center (209). A customer (201-1) uses a computer (202-1) to communicate with the support center (209). Another customer (201-2) uses a telephone (202-2) to communicate with the support center (209). The support center (209) communicates with a customer interaction style presenting system (210). The support center (209) includes a computer (203) for a technician. The computer (203) is communicatively connected to a monitor (204). The monitor (204) displays information to a technician.

The system (200) includes a customer support system (230). The customer support system (230) provides resources and services to a support center (209). The customer support system (230) may be implemented as part of the support center (209) or may reside on a computing system separate from the support center (209). The customer support center (230) includes a customer interaction style presenting system (210). The customer interaction style presenting system (210) may be implemented on the computer (203) associated with a technician. The customer interaction style presenting system (210) may be implemented as a separate computer device communicating with a computer (203) associated with a technician. The customer interaction style presenting system (210) may be implemented separate from the support system (209) and in communication with the support system (209).

The customer interaction style presenting system (210) includes a processor (205) communicatively connected to memory (206). The customer interaction style presenting system (210) communicates with a computer (203) associated with a technician. The customer interaction style presenting system (210) includes a number of modules (214). The modules (214) refer to computer program code which, when executed by the processor (205), performs the designated function of the module (214). As illustrated, the customer interaction style presenting system (210) includes an analyzing module (214-1) and a displaying module (216-2).

The customer interaction style presenting system (210) includes an obtaining module (214-0). The obtaining module (214-0) obtains electronic records related to a particular customer. The electronic records may include information reported by the particular customer. The electronic records include information related to past interactions with the particular customer. The electronic records may be obtained from a customer support system (230). The electronic records may be obtained from other computing devices.

The customer interaction style presenting system (210) includes an analyzing module (214-1). The analyzing module (214-1) analyzes, with a computer, electronic records related to a particular customer to determine a customer interaction style characterizing that particular customer's behavior. The customer interaction style includes a customer focus dimension, the customer focus dimension indicating a degree to which the particular customer seeks an explanation to a solution, a customer work style dimension, the customer work style dimension indicating a rating of the particular customer along a range from self-sufficient to support reliant, and, a customer expression dimension, the customer expression dimension indicating a rating of an extent that the particular customer engages in discussions unrelated to supporting the particular customer's needs.

The customer focus dimension indicates a degree to which the particular customer seeks an explanation to a solution. The customer focus dimension is expressed as a customer focus style score. The customer focus dimension indicates to what degree the particular customer is interested in getting the solution to the issue to the exclusion of details, reasons for the failure, or the nature of the solution. The customer focus dimension indicates the customer interest in understanding a reason for an issue and what a solution does to address those reasons. The customer focus dimension indicates when the customer likes to follow a predefined process where the customer provides details and gets information related to the support issue.

The customer work style dimension indicates a rating of the particular customer along a range from self-sufficient to support reliant. The customer work style dimension is expressed as a customer work style score. The customer work style dimension indicates the level of independence of the customer. The level of independence may be monitored by the number of attempts a customer makes prior to contacting support. The customer work style dimension may indicate the frequency with which the particular customer contacts support to confirm a solution or to seek advice on how to deal with an issue.

The customer expression dimension indicates a rating of an extent that the particular customer engages in discussions unrelated to supporting the particular customer's needs. The customer expression dimension is expressed as a customer expression style score. The customer expression style indicates the sense of urgency a customer places on the issue being raised. The customer expression dimension may include analysis of the urgency a customer placed on previous support issues. The customer expression dimension may also include analysis as to the expected urgency for the past support issues.

The electronic records include information that the customer has reported preferences. For example, customer reported preferences may include contact method preferences and self-reported preferences describing self-sufficiency, detail orientation, and results focus. The electronic records may include information obtained through data analysis. For example, data obtained through analysis may include the number of prior incidents reported, the type of prior incident reported, the average time spent to resolve a prior issue, the urgency placed on prior issues, and the amount of time the customer spent on the prior issues.

The customer interaction style presenting system (210) includes a displaying module (214-2). The displaying module (214-2) provides the customer interaction style information to a technician. The customer interaction style may be displayed for the duration of the support contact. The customer interactions style may be displayed for a portion of the support contact. The customer interaction style may provide an interface for the technician to obtain details as to how the customer interaction style presenting system (210) determined the customer interaction style.

An overall example of FIG. 2A will now be described. A user uses a computer (202-1) to contact a support center (209) over a network (208). The support center (209) identifies the user. The support center (209) communicates over the network (208) with the customer interaction style presenting system (210). The customer interaction style presenting system (210) presents the customer interaction style on the monitor (204) of the computer (203) of a technician in the support center (209). In this example, the customer interaction style (220) is presented as a series of scores. The customer interaction style (220) includes a focus style score (221), a work style score (222), and an expression style score (223). The focus style score (221) represents a customer focus dimension. The work style score (222) represents a customer work style dimension. The expression style score (223) represents a customer expression dimension.

The obtaining module (214-0) obtains electronic records related to a particular customer. The electronic records comprise information related to a customer. The electronic records include information about the customer that is reported by the customer. The electronic records include records of past customer behavior.

The analyzing module (214-1) analyzes electronic records related to a particular customer to determine a customer interaction style characterizing that particular customer's behavior. The analyzing module (214-1) analyzes electronic records that include data reported by the customer and data that is obtained by analyzing previous customer interactions. Data reported by the customer includes customer registration information, such as contact information and customer interaction preferences. Data obtained from the analysis of prior customer interactions may include the number of prior contacts with support, the type of support contact, the amount of time the support contact was open, the amount of time the customer experienced a problem, and the severity of the issue being reported.

The analyzing module (214-1) determines a customer interaction style, as shown in FIG. 1B. The customer interaction style includes a customer focus style score (221), the customer focus style score (221) indicating a degree to which the particular customer seeks an explanation to a solution, a customer work style score (222), the customer work style score (222) indicating a rating of the particular customer along a range from self-sufficient to support reliant, and, a customer expression style score (223), the customer expression style score (223) indicating a rating of an extent that the particular customer engages in discussions unrelated to supporting the particular customer's needs. The fields are expressed as percentages. A customer focus style score (221) is determined to be ninety-seven percent (230-1), indicating that the customer is extremely focused on obtaining a solution to issues raised with support. The customer work style score (222) is determined to be fifty percent (230-2), indicating that the customer is balanced between seeking a solution to an issue from support and working out the issue without support assistance. The customer expression style score (223) is determined to be twelve percent (230-3), indicating that the does not engage in conversations unrelated to the support issue.

The displaying module (214-2) displays the customer interaction style on a monitor (204) associated with a support technician in a support center. As illustrated, the customer interaction style includes a customer focus style score (221), a customer work style score (222), and a customer interaction style score (223). The displaying module (214-2) may allow the technician to see additional information about the customer. The displaying module (214-2) may consume a portion of the monitor (204), allowing the remainder of the monitor to be used for other activities.

FIG. 2B illustrates a display of a customer interaction style to a support technician, according to one example of the principles described herein. The customer interaction style is shown as it is displayed on a monitor of a device associated with a customer support technician.

As illustrated in FIG. 2B, a computer monitor (254) shows example of displaying a customer interaction style. The customer interaction style (270) includes a focus dimension (271), a work style dimension (272), and an expression dimension (273).

The focus dimension (271) indicates the manner a customer focuses on a problem. The focus dimension (271) indicates a result focus (281-1), a logic focus (281-2), and a process focus (281-3). The focus dimension (271) includes a measure of a result focus (281-1). The result focus (281-1) indicates when a customer is interested only in getting the solution to an issue. The customer may not express interest in information on the details or nature of the solution. The focus dimension (271) includes a measure of the logic focus (281-2) of the customer. The logic focus (281-2) indicates the degree to which the customer is interested in what a solution does and the reason why the solution will resolve the customer problem. The focus dimension (271) includes a measure of the process focus (281-3) of the customer. The process focus (281-3) indicates the degree to which the customer desires to follow a defined process, both providing and receiving information.

The work style dimension (272) indicates the work style of the customer. The work style dimension (272) indicates a self-sufficiency style (282-1) and a support reliance style (282-2). The self-sufficiency style (282-1) indicates the level of independence and the number of attempts the customer attempts prior to contacting support. A customer that is self-sufficient attempts to solve a problem without contacting support, or by using material published by the customer support center. The support reliance style (282-2) indicates the level to which a customer contacts support at any point during the resolution problem.

The expression dimension (273) represents the expression style of the customer. The expression dimension (273) indicates a customer urgency style (283-1) and a sociability style (283-2). A customer that engages in discussion unrelated to the support the customer needs may be dissatisfied when a technician does not engage in the conversation. A customer that does not engage in discussion unrelated to the support the customer needs will be dissatisfied with conversation unrelated to the support needs.

The presentation of the customer interaction style (270) provides information to the technician about the customer. Additional space is available on the monitor (254) to allow the technician access to other information. The customer interaction style (270) may be available for the duration of the customer support interaction. The customer interaction style (270) may be available for a portion of the customer support interaction.

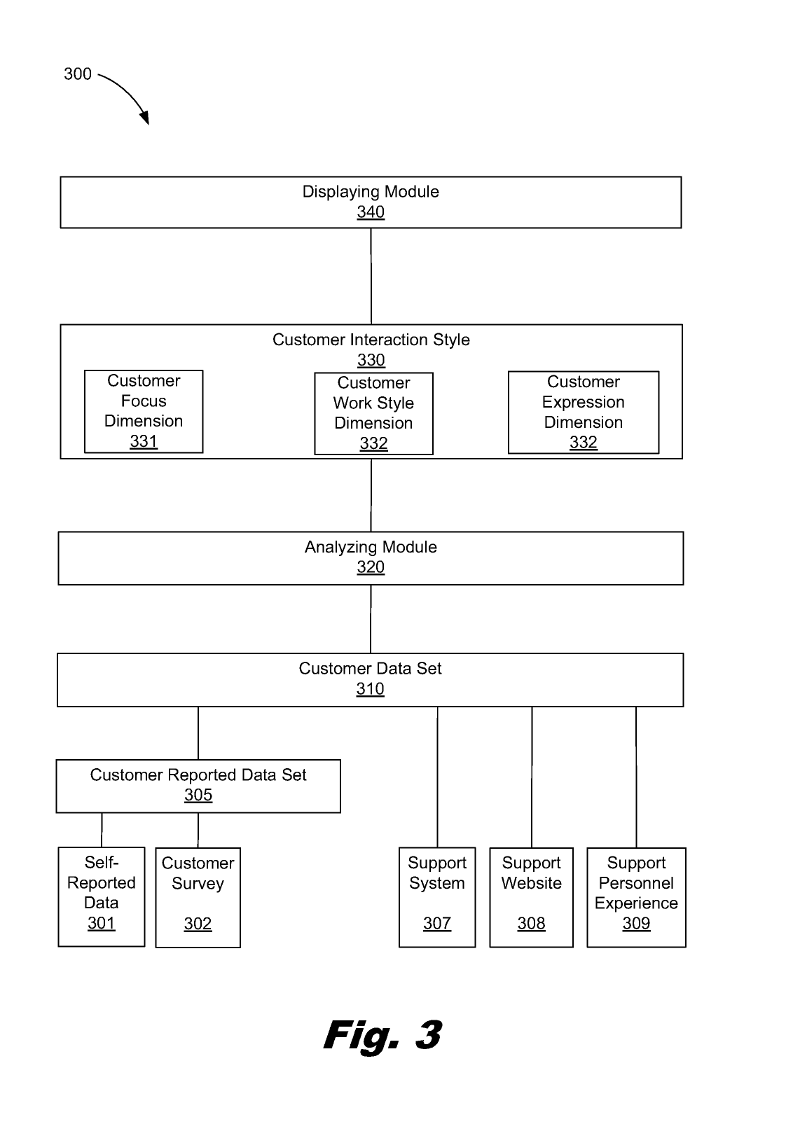

FIG. 3 illustrates a system for presenting a customer interaction style, according to one example of the principles described herein. The system shows data that is used as a customer data set to determine and display a customer interaction style.

A customer reported data set (305) includes data reported by a customer. The customer may be aware that the data reported is to establish communication preferences with a support center. The customer may report data as an evaluation of a support center or support interaction. The customer reported data set (305) receives data from customer self-reported data (301) indicating a data from a questionnaire completed by the customer. The customer reported data set (305) receives data from customer surveys (302), the customer surveys indicating customer opinions regarding support or opinions regarding previous support interactions. The customer data set (305) includes similar data reported data set includes similar data reported by a customer.

A customer data set (310) receives data from the customer reported data set (305). The customer data set (310) receives additional data related to the customer. The customer data set (310) may collect data from a support system (307), indicating information about a customer stored in a support system (307). The customer data set may collect data from a support website (308), the support website (308) storing information of customer interactions with support. The support website (308) may include tracking information from web browsing. The support website (308) may include data shared by the customer in a discussion group. The data shared in a discussion group provides information about the customer's technical ability. The data shared in a discussion group provides information about the prior issues the customer has experienced. The data shared in the discussion group may provide information about issues related to a support interaction. The customer data set (310) receives additional data from support personnel experience (309). A support technician may provide data evaluating a customer after a support interaction. The support personnel experience (309) informs future support interactions based on learning from past interactions. The customer data set (310) includes similar data about a customer.

An analyzing module (320) analyzes electronic records from the customer data set (310) related to a particular customer to determine a customer interaction style (330) characterizing that particular customer's behavior. The analyzing module (320) includes data analysis to determine the meaning of the customer data set (310).

A customer interaction style (330) includes a customer focus dimension (331), a customer work style dimension (332), and a customer expression dimension (333). The customer focus dimension (331) indicates a degree to which the particular customer seeks an explanation to a solution. The customer work style dimension (332) indicates a rating of the particular customer along a range from self-sufficient to support reliant. The customer expression dimension (333) indicates a rating of an extent that the particular customer engages in discussions unrelated to supporting the particular customer's needs.

A displaying module (340) displays a set of guidelines based on the particular customer's expression style to a technician in a support interaction with the particular customer. The displaying module (340) may display the customer interaction style (330). The displaying module (340) may display guidelines for interacting with the customer. The displaying module (340) may display additional information of how the customer interaction style (330) was determined.

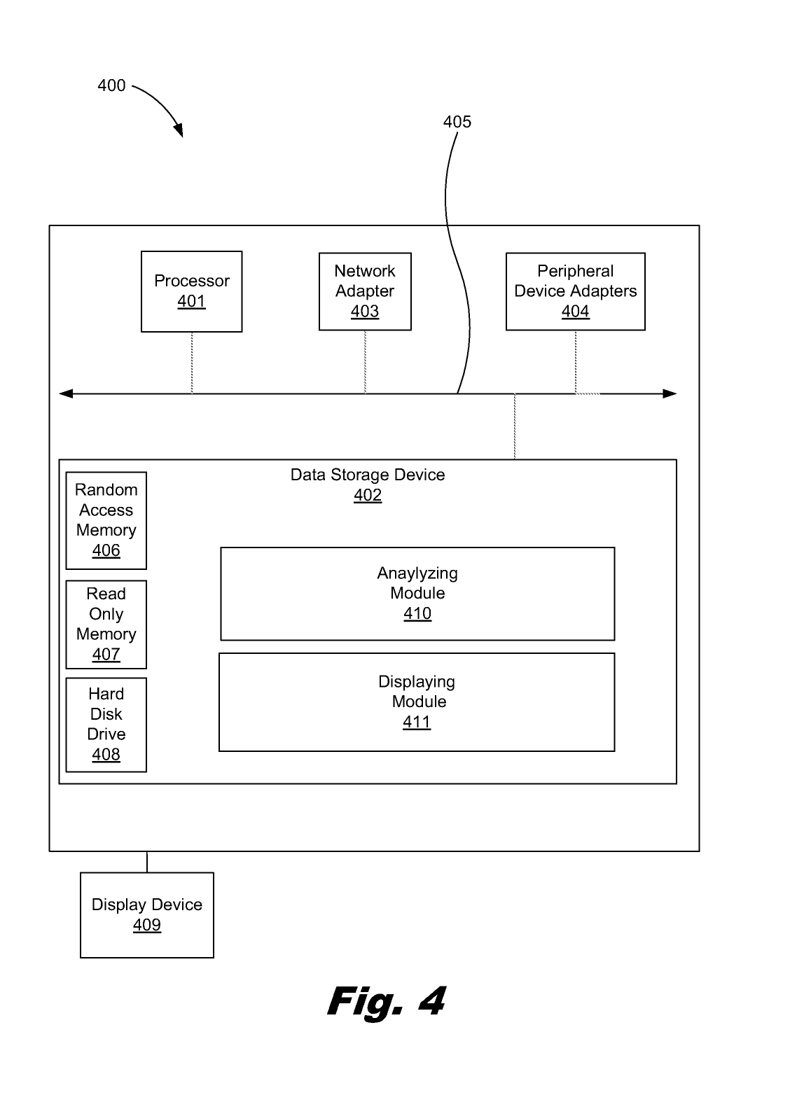

FIG. 4 represents a computing device for presenting a customer interaction style, according to one example of the principles described herein. The computing device (400) for presenting a customer interaction style may be implemented by an electronic device. Examples of electronic devices include servers, desktop computers, laptop computers, personal digital assistants (PDAs), mobile devices, smartphones, gaming systems, and tablets, among other electronic devices.

The computing device (400) may be utilized in any data-processing scenario, including stand-alone hardware, mobile applications, a computing network, or combinations thereof. Further, the computing device (400) may be used in a computing network, a public cloud network, a private cloud network, a hybrid cloud network, other forms of networks, or combinations thereof. In one example, the methods provided by the computing device (400) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, networks, and components, among others; an application program interface (API), or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the computing device (400) are executed by a local administrator.

To achieve its desired functionality, the computing device (400) may include various hardware components. Among these hardware components may be a number of processors (401), a data storage device (402), a number of peripheral adapters (404), and a number of network adapters (403). These hardware components may be interconnected through the use of a number of buses and/or network connections. In one example, the processor (401), data storage device (402), peripheral device adapters (404), and network adapter (403) may be communicatively coupled via a bus (405).

The computing device (400) may include various types of memory modules, including volatile and nonvolatile memory. For example, the data storage device (402) may include Random Access Memory (RAM) (406), Read Only Memory (ROM) (407), and Hard Disk Drive (HDD) memory (408). Many other types of memory may also be utilized, and the present specification contemplates the use of as many varying type(s) of memory in the computing device (400) as may suit a particular application of the principles described herein. In other examples, different types of memory in the computing device (400) may be used for different data storage needs. In some examples, the processor (401) may boot from Read Only Memory (ROM) (407), maintain nonvolatile storage in the Hard Disk Drive (HDD) memory (408), and execute program code stored in Random Access Memory (RAM) (406).

Generally, the computing device (400) may comprise a computer readable medium, a computer readable storage medium, or a non-transitory computer readable medium, among others. For example, the computing device (400) may be, but is not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store computer usable program code for use by, or in connection with, an instruction execution system, apparatus, or device. In another example, a computer readable storage medium may be any non-transitory medium that can contain or store a program for use by, or in connection with, an instruction execution system, apparatus, or device.

The hardware adapters (403, 404) in the computing device (400) enable the processor (401) to interface with various other hardware elements, external and internal to the computing device (400). The peripheral device adapters (404) may provide an interface to input/output devices, such as a display device (409), a mouse, or a keyboard. The peripheral device adapters (403) may also provide access to other external devices, such as an external storage device, a number of network devices, such as servers, switches, and routers, client devices, other types of computing devices, or combinations thereof.

The display device (409) is provided to allow a user of the computing device (400) to interact with and implement the functionality of the computing device (400). An example of a display device (409) is a computer monitor. The peripheral device adapters (404) may also create an interface between the processor (401) and the display device (409), a printer, or other media output devices. The network adapter (403) may provide an interface to other computing devices within, for example, a network, thereby enabling the transmission of data between the computing device (400) and other devices located within the network.

The data storage device (402) may include a number of modules used in providing customer information to a support technician. The various modules within the computing device (400) comprise executable program code that may be executed separately. The various modules may be stored as separate computer program products. The various modules within the computing device (400) may be combined within a number of computer program products; each computer program product comprising a number of the modules.

The computing device (400) includes an analyzing module (410) to electronic records related to a particular customer to determine a customer interaction style characterizing that particular customer's behavior. The customer interaction style includes a customer focus dimension, the customer focus dimension indicating a degree to which the particular customer seeks an explanation to a solution, a customer work style dimension, the customer work style dimension indicating a rating of the particular customer along a range from self-sufficient to support reliant, and, a customer expression dimension, the customer expression dimension indicating a rating of an extent that the particular customer engages in discussions unrelated to supporting the particular customer's needs.

The computing device (400) includes a displaying module (411) to display a set of guidelines based on the particular customer's expression style to a technician in a support interaction with the particular customer. The set of guidelines may include the customer interaction style.

Aspects of the present system and method are described herein with reference to flowchart illustrations and/or block diagrams of methods, apparatus (systems) and computer program products, according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (401) of the computing device (400) or other programmable data processing apparatus, implements the functions or acts specified in the flowchart and/or block diagram block or blocks.

The computer usable program code may be embodied within a computer readable storage medium; the computer readable storage medium being part of the computer program product. The computer readable storage medium may be a non-transitory computer readable medium.

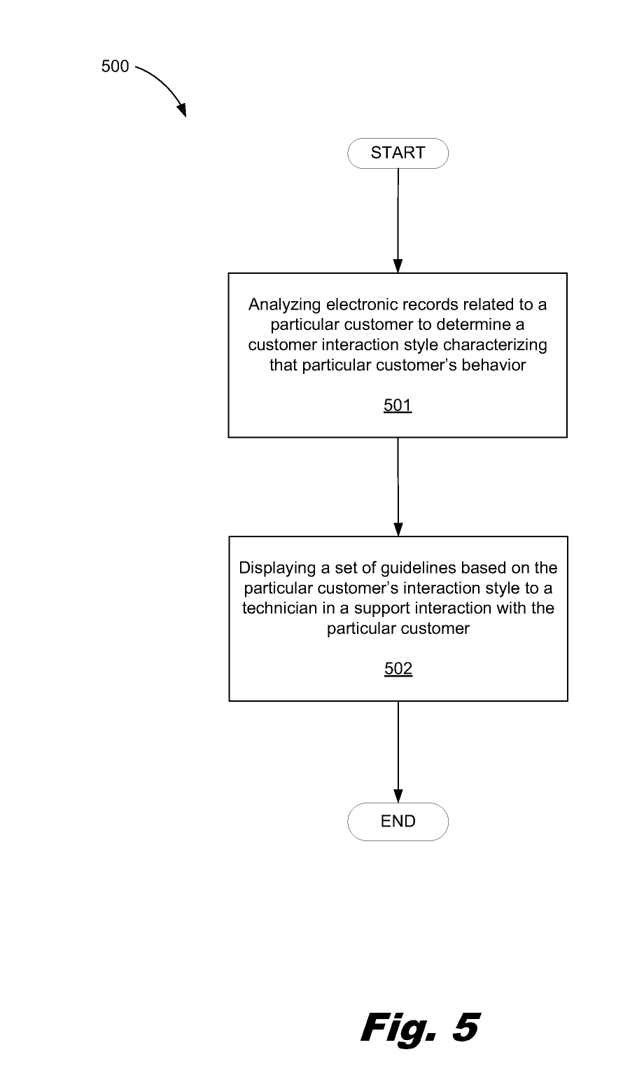

FIG. 5 is a flow chart of a method implemented by a customer interaction style presenting system, according to one example of the principles described herein. The method (500) may be executed by the customer information providing system of FIG. 1. The method may be executed by other systems (i.e. system 200, system 300, system 600). As illustrated, the method (500) includes analyzing (block 501) electronic records related to a particular customer to determine a customer interaction style characterizing that particular customer's behavior, and, displaying (block 502) a set of guidelines based on the particular customer's interaction style to a technician in a support interaction with the particular customer. The customer interaction style includes a customer focus dimension, the customer focus dimension indicating a degree to which the particular customer seeks an explanation to a solution, a customer work style dimension, the customer work style dimension indicating a rating of the particular customer along a range from self-sufficient to support reliant, and a customer expression dimension, the customer expression dimension indicating a rating of an extent that the particular customer engages in discussions unrelated to supporting the particular customer's needs.

As mentioned above, the method (500) includes analyzing (block 501) electronic records related to a particular customer to determine a customer interaction style characterizing that particular customer's behavior. The electronic records include data reported by the particular customer and analysis of interactions with the particular customer.

The customer interaction style includes a customer focus dimension, the customer focus dimension indicating a degree to which the particular customer seeks an explanation to a solution, a customer work style dimension, the customer work style dimension indicating a rating of the particular customer along a range from self-sufficient to support reliant, and a customer expression dimension, the customer expression dimension indicating a rating of an extent that the particular customer engages in discussions unrelated to supporting the particular customer's needs.

As mentioned above, the method (500) includes displaying (block 502) a set of guidelines based on the particular customer's interaction style to a technician in a support interaction with the particular customer. The guidelines are displayed on an output device observable by the technician.

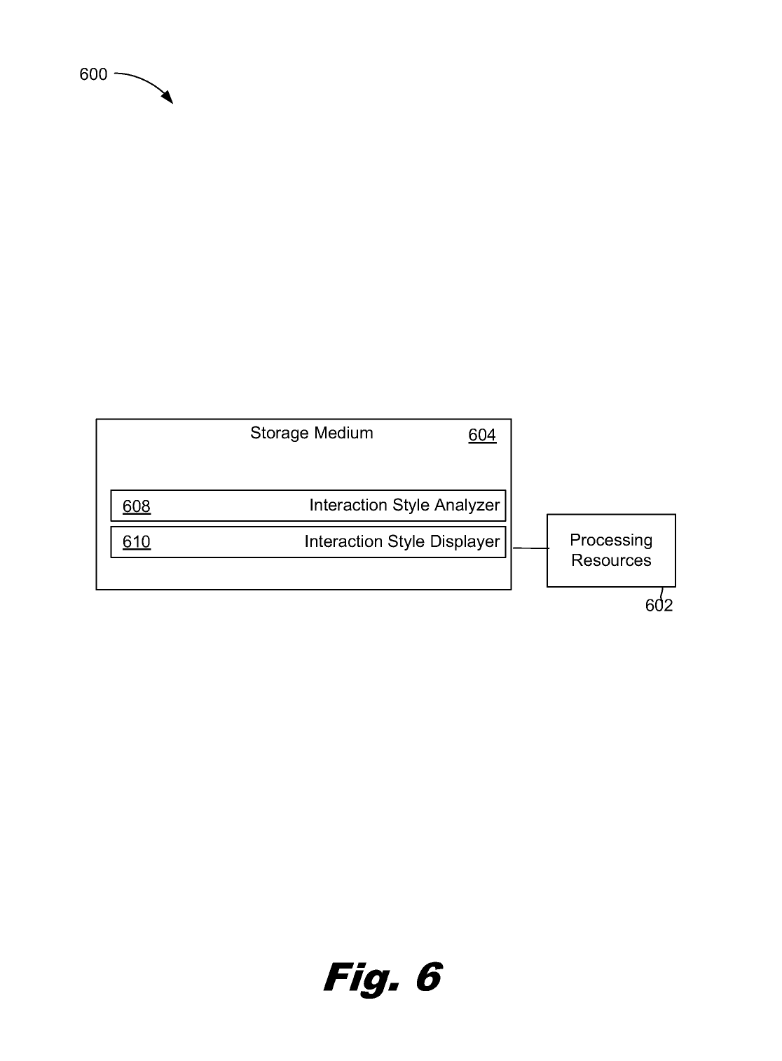

FIG. 6 is a diagram of a customer interaction style presenting system (600) according to one example of the principles described herein. The customer interaction style presenting system (600) includes processing resources (602) that are in communication with memory resources (604). The processing resources (602) include at least one processor and other resources used to process programmed instructions. The memory resources (604) generally represent any memory capable of storing data, such as programmed instructions or data structures to be used by the customer interaction style presenting system (600). The programmed instructions shown stored in the memory resource (604) include an interaction style analyzer (608) and an interaction style displayer (610).

The interaction style analyzer (608) represents programmed instructions that, when executed, cause the processing resource (602) to analyze electronic records related to a particular customer to determine a customer interaction style characterizing that particular customer's behavior. The customer interaction style includes a customer focus dimension, the customer focus dimension indicating a degree to which the particular customer seeks an explanation to a solution, a customer work style dimension, the customer work style dimension indicating a rating of the particular customer along a range from self-sufficient to support reliant, and, a customer expression dimension, the customer expression dimension indicating a rating of an extent that the particular customer engages in discussions unrelated to supporting the particular customer's needs.

The interaction style displayer (610) represents programmed instructions that, when executed, cause the processing resource (602) to display a set of guidelines based on the particular customer's interaction style to a technician in a support interaction with the particular customer.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicates otherwise. It will be further understood that the terms “comprises” and/or “comprising,” when used in the specification, specify the presence of stated features, integers, operations, elements, and/or components, but do not preclude the presence or addition of a number of other features, integers, operations, elements, components, and/or groups thereof.

What is claimed is:

1. A computer implemented method for providing customer information to a support technician, the method comprising:
with a computer, analyzing electronic records related to a particular customer to determine a customer interaction style, the customer interaction style comprising:
a customer focus dimension, the customer focus dimension indicating a degree to which the particular customer seeks an explanation with a provided solution;
a customer work style dimension, the customer work style dimension indicating a rating of the particular customer along a range from self-sufficient to support reliant; and
a customer expression dimension, the customer expression dimension indicating an amount in which the particular customer engages in discussion unrelated to the provided solution; and,
with a computer, generating and displaying a set of guidelines based on the particular customer's expression style to a technician in a support interaction with the particular customer.

2. The method of claim 1, wherein the electronic records related to the particular customer comprise data reported by the particular customer to describe a customer interaction request.

3. The method of claim 1, wherein displaying the set of guidelines comprises displaying the customer focus dimension, the customer work style dimension, and the customer expression dimension.

4. The method of claim 1, wherein the degree to which the particular customer seeks an explanation with a provided solution further comprises a degree to which the particular customer seeks a reason that a particular problem has occurred.

5. The method of claim 1, wherein the customer work style dimension further indicates a frequency that the particular customer has contacted a support technician.

6. The method of claim 1, wherein the customer expression dimension further indicates an urgency the particular customer has assigned to past problems.

7. The method of claim 6, wherein the customer expression dimension further indicates an expected urgency for the past problems.

8. A system for presenting a customer interaction style to a technician, the system comprising:
a processor;
memory to communicate with the processor;
a computer monitor to communicate with the processor; and
a support style system comprising:
an analyzing module to analyze electronic records related to a particular customer to determine a customer interaction style and generate a set of guidelines based on the customer interaction style, the customer interaction style comprising:
a customer focus dimension, the customer focus dimension indicating a degree to which the particular customer seeks an explanation with a provided solution;
a customer work style dimension, the customer work style dimension a rating of the particular customer along a range from self-sufficient to support reliant; and
a customer expression dimension, the customer expression dimension quantifying an amount in which the particular customer engages in discussion unrelated to the provided solution; and,
a displaying module to display, on the computer monitor, the set of guidelines during an interaction between a support technician and the particular customer.

9. The system of claim 8, wherein the electronic records related to the particular customer comprise data reported by the particular customer to describe a customer interaction request.

10. The system of claim 8, wherein the displaying module displays the customer focus dimension, the customer work style dimension, and the customer expression dimension.

11. The system of claim 8, wherein the degree to which the particular customer seeks an explanation with a provided solution further comprises a degree to which the particular customer seeks a reason that a particular problem has occurred.

12. The system of claim 8, wherein the customer work style dimension further indicates a frequency that the particular customer has contacted a support technician.

13. The system of claim 8, wherein the customer expression dimension further indicates an urgency the particular customer has assigned to past problems.

14. The system of claim 13, wherein the customer expression dimension further indicates an expected urgency for the past problems.

15. A computer program product for providing customer information to a technician, the computer program product comprising a non-transitory computer readable storage medium, said computer readable storage medium comprising computer readable program code embodied therewith, said computer readable program code comprising program instructions that, when executed, cause a processor to:
analyze electronic records related to a particular customer to determine a customer interaction style and generate a set of guidelines based on the customer interaction style, the customer interaction style comprising:
a customer focus dimension, the customer focus dimension indicating a degree to which the particular customer seeks an explanation with a provided solution;
a customer work style dimension, the customer work style dimension indicating a rating of the particular customer along a range from self-sufficient to support reliant; and
a customer expression dimension, the customer expression dimension indicating an amount in which the particular customer engages in discussion unrelated to the provided solution; and,
display the set of guidelines to a technician in a support interaction with the particular customer.

16. The product of claim 15, wherein the electronic records related to the particular customer comprise data reported by the particular customer to describe a customer interaction request.

17. The product of claim 15, wherein displaying the set of guidelines based on the particular customer's interaction style comprises instructions to, when executed by the processor, display the customer focus dimension, the customer work style dimension, and the customer expression dimension.

18. The product of claim 15, wherein the degree to which the particular customer seeks an explanation with a provided solution further comprises a degree to which the particular customer seeks a reason that a particular problem has occurred.

19. The product of claim 15, wherein the customer work style dimension further indicates a frequency that the particular customer has contacted a support technician.

20. The product of claim 15, wherein the customer expression dimension further indicates an urgency the particular customer has assigned to past problems.
